(19) United States
(12) Patent Application Publication
(10) Pub. No.: US 2026/0277080 A1
(43) Pub. Date: Sep. 17, 2026

(54) SYSTEMS AND METHODS OF MOUNTING A CAMERA FOR MONITORING AN ITEM STORAGE AREA OF A FACILITY

(71) Applicant: Walmart Apollo, LLC, Bentonville, AR (US)

(72) Inventors: Daniel J. Turk, Brooklyn, NY (US); Adam F. Gobi, Rogers, AR (US); Robert J. King, Milton, DE (US); Michael A. Garner, Centerton, AR (US); Daniel R. Bersak, Astoria, NY (US)

(21) Appl. No.: 19/080,674

(22) Filed: Mar. 14, 2025

(51) Int. Cl. G03B 17/56; H04N 23/611

(52) U.S. Cl. CPC G03B 17/561; H04N 23/611

(57) ABSTRACT

A mounting system to mount a camera for monitoring an item storage area of a facility includes a first housing containing a camera that captures the item storage area's field of view, and a second housing containing a battery pack that supplies power to the camera. An electrical wire connects the battery pack to the camera. A bracket is mounted to an item storage structure, with a front leg supporting the first housing at the front of the structure, and a rear leg supporting the second housing at the back of the structure. The body portion of the bracket connects the front and rear legs, allowing the electrical wire to travel along it. The positioning of the battery pack behind the item storage structure protects the battery pack from potential impacts by machinery at the front of the structure, ensuring that the camera and battery pack remain functional and secure.

### TECHNICAL FIELD

This invention relates generally to mounting systems within a facility and, more particularly, to camera mounting systems for monitoring one or more areas of the facility.

### BACKGROUND

In modern facilities, the camera systems used for monitoring item storage areas often face several challenges related to power supply and placement. Some conventional camera mounting systems require external power sources that can be difficult to integrate within the item storage environment. Additionally, these systems often position cameras and/or power sources in locations where they are vulnerable to impacts from machinery or other movable equipment or devices used within the storage area. As a result, cameras and power supplies may be damaged or obstructed, impairing their functionality and reducing the overall reliability of the monitoring system. Furthermore, mounting brackets in current systems may not effectively shield power supplies, such as battery packs, from external forces. This can lead to premature wear, loss of power, or damage to the battery pack, thus compromising the camera's performance.

### BRIEF DESCRIPTION OF DRAWINGS

Disclosed herein are embodiments of systems, apparatuses and methods pertaining to camera mounting systems for monitoring an item storage area of the facility. This description includes drawings, wherein:

FIG. 1 is a perspective view of a system for mounting an item storage area of a facility when the mounting system is mounted on a portion of an item storage structure in accordance with some embodiments;

FIG. 2 is an enlarged fragmentary front perspective view of the system and the portion of the item storage structure of FIG. 1 in accordance with several embodiments;

FIG. 3 is a rear perspective view of the system and the portion of the item storage structure shown in FIG. 2 in accordance with several embodiments;

FIG. 4 is a bottom perspective view of the system and the portion of the item storage structure shown in FIG. 2 in accordance with several embodiments;

FIG. 5 is a top view of the system and the portion of the item storage structure shown in FIG. 2 in accordance with several embodiments;

FIG. 6 is a bottom view of the system and the portion of the item storage structure shown in FIG. 2 in accordance with several embodiments;

FIG. 7 is a side elevational view of the system and the portion of the item storage structure shown in FIG. 2 in accordance with several embodiments;

FIG. 8 is a front perspective view of the system of FIG. 1 when the mounting system is not mounted on a portion of an item storage structure in accordance with several embodiments;

FIG. 9 is an exploded view of the system of FIG. 8 in accordance with several embodiments;

FIG. 10 is a perspective side view of the system of FIG. 8 in accordance with several embodiments;

FIG. 11 is a block diagram of a camera and a battery pack of the system of monitoring an item storage area of a facility in accordance with some embodiments; and

FIG. 12 is a block diagram of a method of monitoring an item storage area of a facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein for mounting system designed to securely position a camera for monitoring an item storage area within a facility. The system includes a first housing that contains a camera with a field of view directed toward the item storage area, and a second housing that holds a battery pack providing operational power to the camera. An electrical wire connects the battery pack to the camera, ensuring continuous power supply. The system also features a bracket that is mounted to an item storage structure. The bracket includes a front leg that supports the first housing at the front of the structure and a rear leg that supports the second housing at the back of the structure. The body portion of the bracket connects the front and rear legs, providing a path for the electrical wire to travel between them. The position of the battery pack behind the item storage structure protects the battery pack from potential impacts by machinery or equipment at the front of the structure and ensures that the camera and the battery pack remain secure and operational.

In some embodiments, a system for monitoring an item storage area of a facility includes: a first housing containing a camera having a field of view that includes the item storage area of the facility; a second housing containing a battery pack operatively coupled to the camera to provide operational power to the camera; an electrical wire coupled to the battery pack and the camera; and a bracket mounted to an item storage structure in the item storage area, the bracket including: a front leg having a surface that rigidly contacts a front of the item storage structure facing an aisle and supports the first housing at the front of the item storage structure facing the aisle; a rear leg having a fastener that rigidly contacts a back of the item storage structure facing away from the aisle and supports the second housing at the back of the item storage structure facing away from the aisle; and a body portion that connects the front leg and the rear leg, wherein the electrical wire travels along the body portion between the front leg and the rear leg. The bracket situates the battery pack proximate the rear leg behind the item storage structure to protect the battery pack from potential machinery impact at the front of the item storage structure.

In some embodiments, a bracket to mount a camera and a battery pack, the camera and the battery pack being interconnected by an electrical wire, to an item storage structure of a facility includes: a front leg having a surface that rigidly contacts a front of the item storage structure facing an aisle and supports a first housing containing the camera at the front of the item storage structure facing the aisle; a rear leg having a fastener that rigidly contacts a back of the item storage structure facing away from the aisle and supports a second housing containing the battery pack at the back of the item storage structure facing away from the aisle; and a body portion that connects the front leg and the rear leg, wherein the electrical wire travels along the body portion between the front leg and the rear leg. The bracket situates the battery pack proximate the rear leg behind the item storage structure to protect the battery pack from potential machinery impact at the front of the item storage structure.

In some embodiments, a method of monitoring an item storage area of a facility includes: providing power to a camera, the camera having a field of view that includes the item storage area of the facility, from a battery pack operatively coupled to the camera via an electrical wire to provide operational power to the camera, the battery pack and the camera being coupled to an item storage structure of the facility such that the camera is positioned at a front of the item storage structure and the battery pack is positioned behind the item storage structure to protect the battery pack from potential machinery impact at the front of the item storage structure; and capturing an image of the item storage area via the camera.

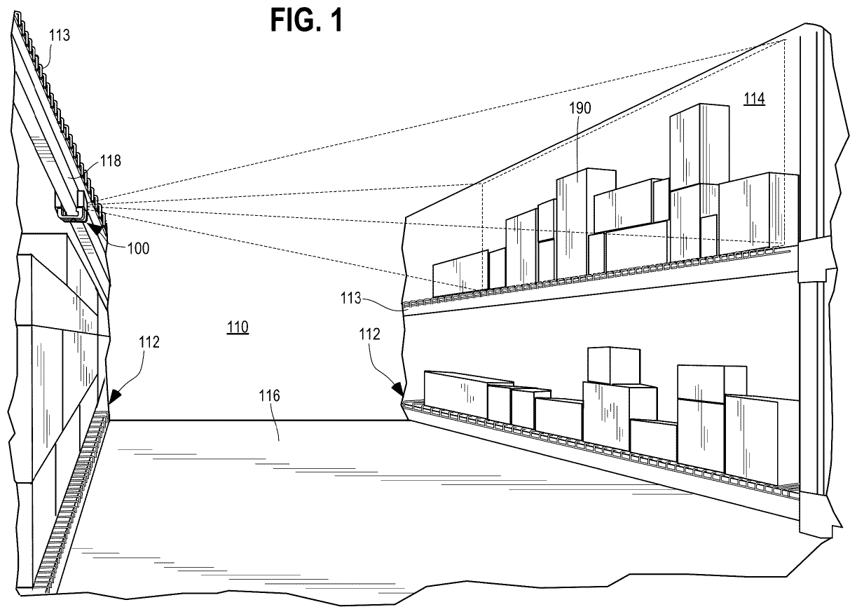

FIG. 1 shows a system 100 (which may be referred to herein as a “mounting system” or a “system for mounting”) mounted on an item storage structure 112 of a facility 110 to monitor an item storage area 114 of the facility 110 in accordance with some embodiments. In some embodiments, the facility 110 may be any facility where items (e.g., retail and/or commercial products, products that are not for sale, etc.) are stored, displayed, and/or sold, such as a warehouse, an order fulfillment facility, a product distribution center, a retail store, or the like. In some aspects, the facility may be any facility, where mounted cameras and movable machinery may be used.

For simplicity of illustration, only system 100 is shown in FIG. 1 being mounted on one item storage structure 112 to monitor only one item storage area 114 (which, in this example, includes two product display shelves 113 and products 190 located thereon). It will be appreciated that, depending on the size of the facility 110, the facility 110 may include dozens or hundreds of mounting systems 100 mounted on dozens or hundreds of item storage structures 112 throughout the facility 110 to monitor hundreds or thousands of item storage areas 114 containing hundreds or thousands of products 190.

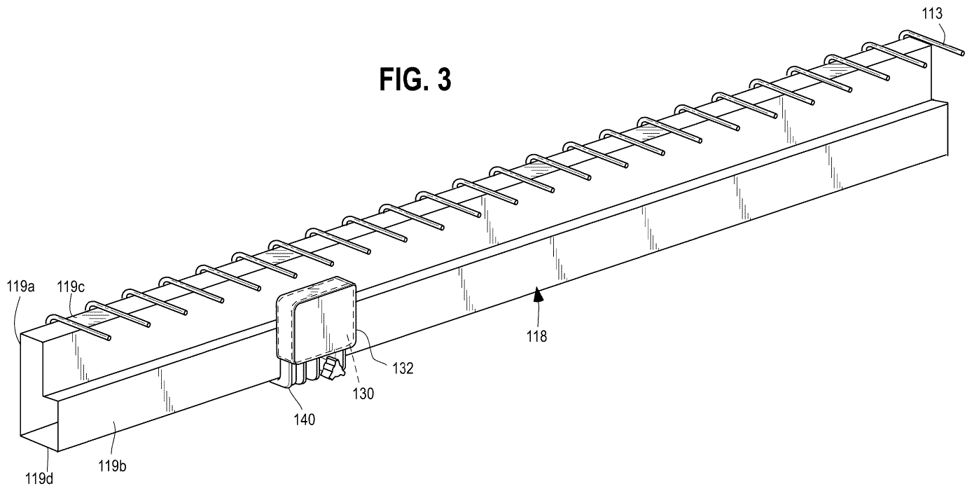

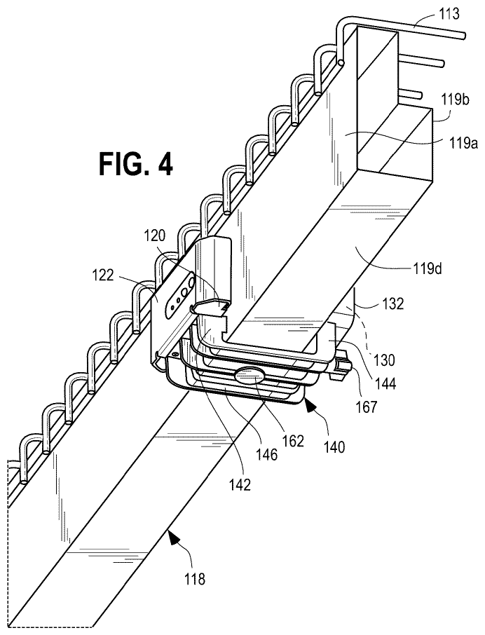

In the embodiment illustrated in FIGS. 1-6, the system 100 for mounting a camera 120 to an item storage structure 112 for monitoring an item storage area 114 at a facility 110 generally includes a camera 120, a battery pack 130, and a bracket 140. The system 100 is mounted on the item storage structure 112 such that the camera 120 faces an aisle 116 located between the item storage structure 112 on which the system 100 is mounted and the item storage structure 112 located across the aisle 116 and including the item storage area 114 that contains products 190 thereon.

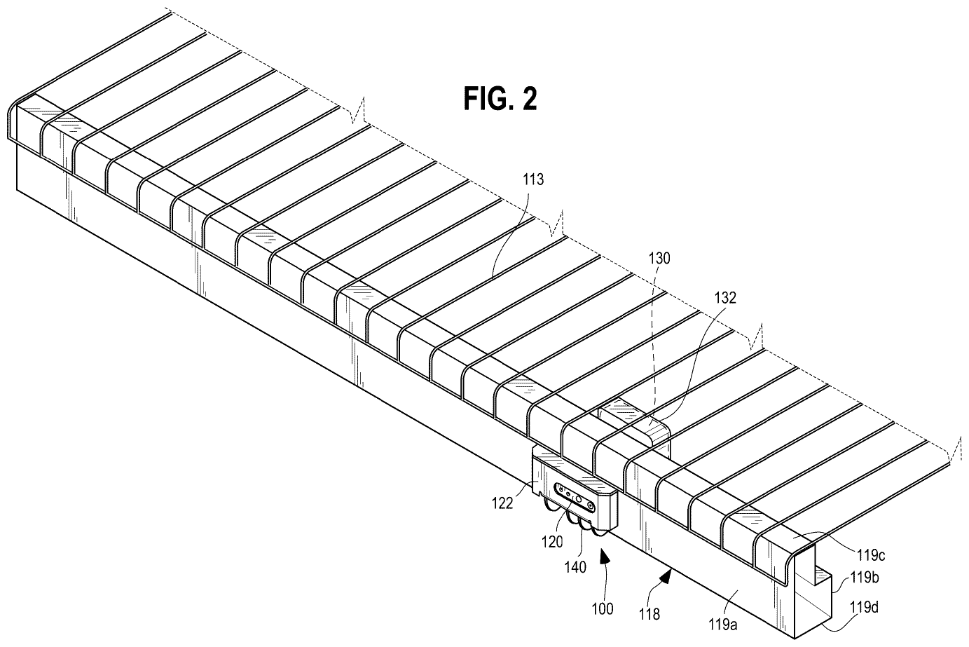

With reference to FIGS. 2-6, the system 100 may be mounted on a support member 118 of the item storage structure 112, for example, a bar, beam, or the like. The support member 118 may be a part of the product storage/display shelf 113 of the item storage structure 112, or may be a structure that is separate and distinct from the product storage/display shelf 113 and on which the product storage/display shelf 113 is supported. In some aspects, the support member 118 of the item storage structure 112 may be made of metal (e.g., steel) or another rigid material that is not susceptible to deformation when impacted by a moving object such as a cart (shopping cart, pick cart, etc.), forklift, autonomous vehicle, or the like that may move through the aisle 116 of the facility 110.

In addition, as shown in more detail in FIGS. 2-4, the bracket 140 is mounted to a support member 118 (in this example, a bar or beam) of the item storage structure 112 such that the camera 120 is located at the front of the support member 118 and faces the aisle 116, while the battery pack 130 is located behind the support member 118 of the item storage structure 112 and faces away from the aisle 116. The positioning of the battery pack 130 separately from the camera 120 and behind the support member 118 advantageously protects the battery pack 130 from potential impact by devices (e.g., carts, human operated machinery and/or vehicles, etc.) that may move through the aisle 116 adjacent the front of the item storage structure 112. The bracket 140 may be made of a rigid material, for example, a plastic, composite, metal, or the like material that would support the camera 120 and the battery back 130 and resist deformation in the event of an impact at the front of the item storage structure 112 by a moving object (e.g., vehicle). In some aspects, the bracket 140 may be made from a corrosion-resistant material.

In the illustrated embodiment, the camera 120 of the system 100 depicted in FIG. 1 is mounted on the item storage structure 112 such that the camera 120 is oriented to have a field of view that includes the item storage area 114 (which may include at least a portion of one or more product storage/display shelves 113) of the item storage structure 112 located across an aisle 116 from the item storage structure 112 on which the system 100 is mounted. The field of view of the camera 120 of the system 100 is shown in FIG. 1 as the dashed lines extending from the system 100 onto the item storage area 114. The position and orientation of the camera 120 as shown in FIG. 1 permits the camera 120 to detect the presence and/or absence of the products stored in the item storage area 114 and/or to detect one or more identifying characteristics of the products 190 stocked in the item storage area 114.

In the illustrated embodiment, the camera 120 can include one or more sensors including but not limited to: a digital camera sensor 121, a motion sensor 123 to detect motion indicative of the presence of a person or other object near the camera 120 and/or proximate a field of view of the digital camera sensor 121, a light guide/light emitting diode (LED) sensor 125, and a reset button 127 (which may be recessed relative to a front face of the camera 120 such that a user would insert an object (e.g., a pin) into a recess and press the reset button 127 to reset/restart the camera 120. In certain aspects, the camera 120 may include a 3-D sensor, a depth sensor, a quick response (QR) code sensor, a radio frequency identification (RFID) sensor, a near field communication (NFC) sensor, a stock keeping unit (SKU) sensor, and/or a barcode (e.g., electronic product code (EPC), universal product code (UPC), European article number (EAN), global trade item number (GTIN)) sensor, or the like.

In some aspects, the camera 120 is configured to scan identifying indicia (e.g., a label) on a product 190 located within the item storage area 114. The identifying indicia or label that may be scanned by the camera 120 may include, but is not limited to: two-dimensional barcode, RFID, near field communication (NFC) identifiers, ultra-wideband (UWB) identifiers, Bluetooth identifiers, images, or other such optically readable, radio frequency detectable or other such code, or combination of such codes.

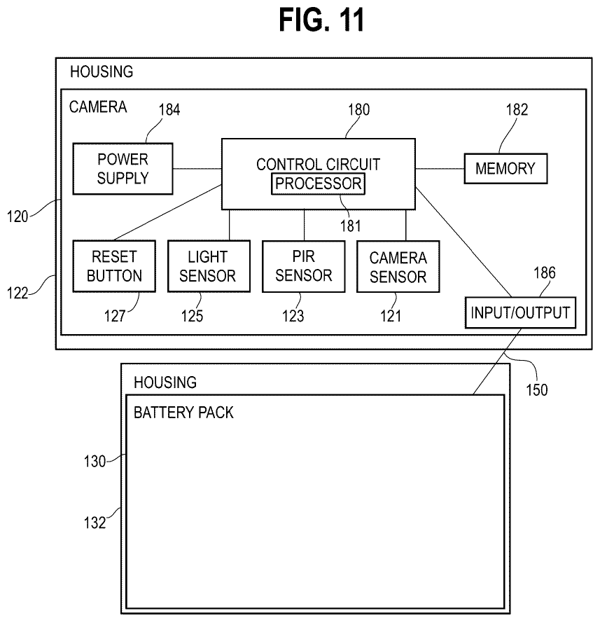

With reference to FIG. 11, a camera 120 configured for use with exemplary systems and methods described herein may include control circuit 180 including a processor 181 (e.g., a microprocessor or a microcontroller) electrically coupled to a memory 182 and a power supply 184. The control circuit 180 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control circuit 180 can be configured (for example, by using corresponding programming stored in the memory 182 as will be well understood by those skilled in the art) to carry out one or more of the steps, actions, and/or functions described herein. In some embodiments, the memory 182 may be integral to the control circuit 180 or can be physically discrete (in whole or in part) from the control circuit 180 and is configured non-transitorily store the computer instructions that, when executed by the control circuit 180, cause the control circuit 180 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory 182 and/or the control circuit 180 may be referred to as a non-transitory medium or non-transitory computer readable medium.

In the illustrated embodiment, the control circuit 180 of the camera is also electrically coupled to an input/output 186. In some aspects, the input/output 186 of the camera 120 may receive a connector of the electrical wire 150 to permit a connection of the first housing 122 containing the camera 120 and the second housing 132 containing the battery pack 130, whereby the battery pack 130 provides operational power to the camera 120 via the electrical wire 150.

The control circuit 180 of the camera 120 is shown in FIG. 11 as electrically coupled to a camera sensor 121, motion sensor 123, light sensor 125, and reset button 127, but it will be appreciated that the control circuit 180 may be coupled to one or more additional sensors.

As mentioned above, in some embodiments, the motion sensor 123 of the camera 120 detects the presence of a person and/or another object in proximity to the camera 120 and/or within the field of view of the digital camera sensor 121. It will be appreciated that, in some embodiments, the motion sensor 123 of the camera 120 may include one or more suitable sensors, including but not limited to a passive infrared (PIR) sensor microwave field disturbance sensor, a light detection and ranging (LIDAR) sensor, an ultrasonic sensor, a thermal sensor, or the like. When the motion sensor 123 detects a person nearby (e.g., in an aisle 116), the motion sensor 123 may trigger a response that automatically disables the camera 120 to prevent the camera 120 from capturing an image of this person. For example, with reference to FIG. 11, in some embodiments, when the motion sensor 123 of the camera 120 detects the presence of a person in proximity to the camera 12, the motion sensor 123 transmits a signal to the control circuit 180, and the control circuit 180, in response to receiving a signal from the motion sensor 123 indicating that a person (e.g., walking in the aisle 116) has been detected by the motion sensor 123, may send a signal to the camera sensor 121 to disable the camera sensor 121 and prevent the camera 120 from capturing an image of this person. This feature may be advantageous in maintaining privacy of individuals located at the facility 110, as this feature ensures that the camera 120 does not record or capture images of people located in the aisle 116 of the facility 110, thus balancing on-hand inventory monitoring needs of the facility 110, as well as privacy concerns of individuals that may be present at the facility 110. The feature of not recording or capturing images of people located in the aisle 116 of the facility 110 and not transmitting large digital video files and photo images depicting people over the network to which the camera 120 is connected may also advantageously conserve the bandwidth of the network to which the camera 120 is connected.

The camera 120 may store (in compressed or uncompressed form) any images captured by the camera 120 in the memory 182 (shown in FIG. 11) that is internal to the camera 120. The camera 120 may be connected to a network to enable the camera 120 to transmit (in compressed or uncompressed form) any images captured by the camera 120 over the network to a computing device, server, or cloud-based service, for example, for object detection, product identification, or other analysis, or to an electronic database for storage and subsequent retrieval. In some aspects, the images captured by the camera 120 provide for detection of products 190 on product storage/display shelves 113 of item storage structures 112 at the facility 110, which in turn facilitates accurate monitoring and/or managing of the inventory located in item storage areas 114 of the facility 110.

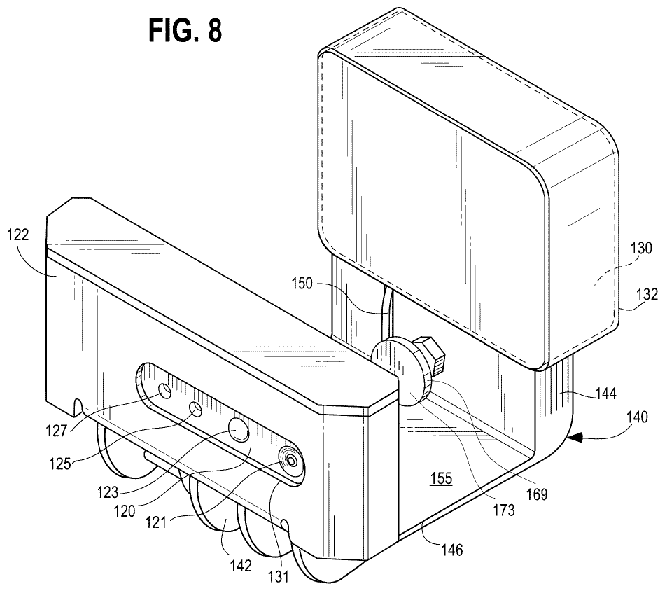

With reference to FIG. 8, the camera 120 may be partially enclosed in a housing 122, which may be referred to herein as a “first housing.” In the embodiment illustrated in FIG. 8, the first housing 122 wraps around the front face, sides, and portions of the rear face of the camera 120 and is fixedly attached to the camera 120 using fasteners 129 (but other suitable means alternative to the fasteners 129 may be used instead). As shown in FIG. 8, the first housing 122 includes a cutout 131 (which is shown as oval-shaped, but could be of another shape) positioned in alignment with the digital camera sensor 121, motion sensor 123, light-emitting sensor 125, and reset button 127 of the camera 120. As such, the first housing 122 does not obstruct any of the digital camera sensor 121, motion sensor 123, light-emitting sensor 125, and reset button 127 of the camera 120.

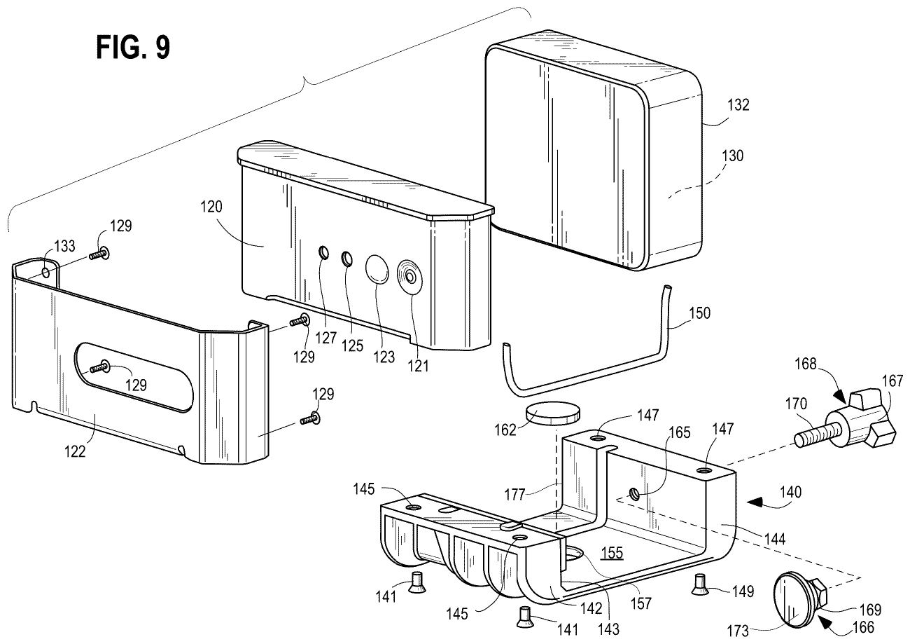

The first housing 122 may be made from a material (e.g., steel or the like) that is sufficiently rigid and resistant to deformation and/or damage when impacted by a moving object such as a cart (shopping cart, pick cart, etc.), forklift, autonomous vehicle, or the like that may move through the aisle 116 of the facility 110. As such, the first housing 122 protects the camera 120 against damage that may be caused by an impact at the front the item storage structure 112 facing the aisle 116. In the embodiment illustrated in FIG. 9, the first housing 122 is securely (e.g., non-movably) attached to the bracket 140 by virtue of being securely attached to the camera 120 (i.e., via fasteners 129 passing through complementary openings 133 of the first housing 122, as seen in FIG. 9) while the camera 120 is in turn securely attached to the bracket 140. In particular, in the illustrated embodiment, fasteners 141 pass through openings 145 front leg 142 of the bracket 140 and through a portion (e.g., a threaded recess) of the camera 120 to securely attach the camera 120 to the bracket 140, and thereby securely retain the first housing 122 relative to the bracket 140.

It will be appreciated that, in some alternative embodiments, the first housing 122 and the camera 120 do not have to be non-movably attached to the bracket 140. Instead, the first housing 122 may be attached to the bracket 140 in such a way that both the first housing 122 and the camera 120 retained within it are capable of movement, such as swiveling or rotating, allowing the camera 120 to capture a wider portion of the item storage area 114. Such a configuration may provide the system 100 with an ability to monitor item storage areas 114 of larger sizes.

With further reference to FIG. 8, the battery pack 130 may be at least partially enclosed in a housing 132, which may be referred to herein as a “second housing.” In the embodiment illustrated in FIG. 8, the second housing 132 wraps around and fully encloses the battery pack 130. Since, by virtue of being positioned behind the support member 118 of the item storage structure 112 as shown in FIGS. 2-7, the battery pack 130 is protected from impact by objects moving in the aisle 116, and the second housing 132 does not need to be made from a material that as rigid as the material from which the first housing 122 is made. For example, the second housing 132 may be made from materials including but not limited to plastic (e.g., composite) materials, rubber, silicone, aluminum, and the like. In the embodiment illustrated in FIG. 9, the second housing 132 containing the battery pack 130 is securely attached to the bracket 140 by one or more fasteners 149 passing through openings 147 in a rear leg 144 of the bracket 140 and through a portion (e.g., a downward-facing threaded recess or opening) of the second housing 132 to securely attach the second housing 132 and the battery pack 130 to the bracket 140.

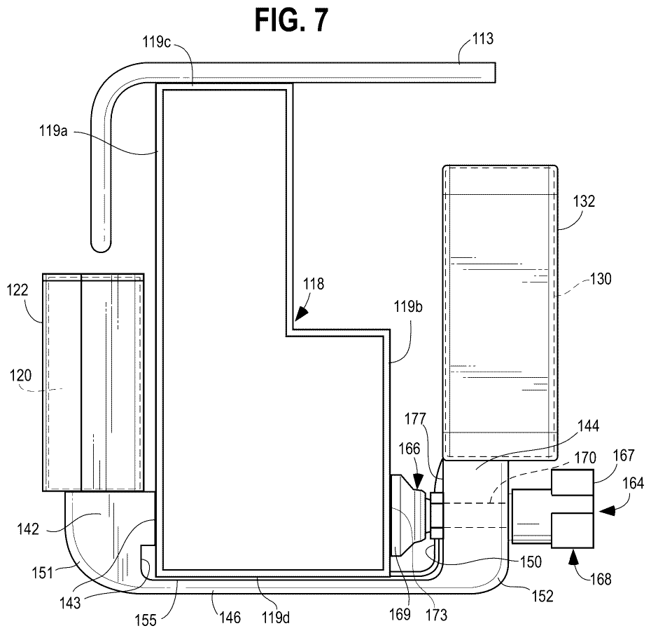

In the embodiment illustrated in FIGS. 8-10, the bracket 140 includes a front leg 142, a rear leg 144 opposite the front leg 142, and a body portion 146 that connects the front leg 142 and the rear leg 144 and effectively serves as a bridge between the front leg 142 and the rear leg 144 of the bracket 140. As shown, for example, in FIG. 7, the front leg 142 has a rearwardly-facing surface 143 that faces away from the aisle 116 and that rigidly contacts a front side 119a of the support member 118 of the item storage structure 112 facing the aisle 116.

In some aspects, the front leg 142 of the bracket 140 is fixedly attached to and supports the first housing 122 (which contains the camera 120) at the front of the item storage structure 112 facing the aisle 116, as shown, for example, in FIGS, 2-7. As mentioned above, in the illustrated embodiment, fasteners 141 pass through openings 145 of the front leg 142 of the bracket 140 and through portions (e.g., downward-facing threaded openings or recesses) of the first housing 122 and/or the camera 120 to securely attach both the camera 120 and the first housing 122 to the bracket 140.

In some aspects, the rear leg 144 of the bracket 140 is fixedly attached to and supports the second housing 132 (which contains the battery pack 130) at the rear of the item storage structure 112 facing away from the aisle 116, as shown, for example, in FIGS. 2-7. As mentioned above, in the illustrated embodiment, fasteners 149 pass through openings 147 in the rear leg 144 of the bracket 140 and through a portion (e.g., a threaded recess) of the second housing 132 to securely attach the second housing 132 (and the battery pack 130 contained therein) to the bracket 140. As mentioned previously, one significant advantage that the bracket 140 offers is that the bracket 140 situates the battery pack 130 behind the support member 118 of the item storage structure 112, protecting the battery pack 130 from potential impact from machinery or other equipment moving through the aisle 116 at the front of the item storage structure 112.

In some embodiments, the body portion 146 of the bracket 140 is oriented generally horizontally, and the front leg 142 and the rear leg 144 of the bracket 140 are oriented generally vertically, such that the front leg 142 and rear leg 144 are parallel to each other, but perpendicular to the body portion 146. In the embodiment shown in FIG. 7, the front leg 142 and the rear leg 144 do not intersect the body portion 146 to form a right (i.e., 90 degree) angle at the intersection. Instead, the bracket 140 includes a first curved transition 151 between the front leg 142 and the body portion 146 and a second curved transition 152 between the rear leg 144 and the body portion 146. However, it will be appreciated that, depending on the exterior shape of the support member 118 to which the bracket 140 is mounted, the front leg 142 and the rear leg 144 may intersect the body portion 146 to form a right angle, or may be oriented at an angle than is less than or greater than a right angle relative to the body portion 146.

In the illustrated embodiment, the camera 120 and the battery pack 130 are interconnected by an electrical wire 150, which enables the battery pack 130 to provide power to the camera 120. In some aspects, a distal end of the electrical wire 150 may include a plug-in adapter, which permits the electrical wire 150 to be plugged into a charging port of the camera 120. In certain implementations, the battery pack 130 may be rechargeable, and the electrical wire 150 may be unplugged from the camera 120 and plugged into a power source to recharge the battery pack 130, after which the recharged battery pack 130 may be connected back to the camera 120 via a plug-in adapter of the electrical wire 150.

In some aspects, the electrical wire 150 extends from the battery pack 130 to the camera 120 along the bracket 140. In the embodiment illustrated in FIGS. 7-10, the electrical wire 150 extends from the battery pack 130 in a downwardly direction along the rear leg 144 of the bracket 140, then in a horizontal direction along the body portion 146 of the bracket 140, and then in an upwardly direction along the front leg 142 of the bracket 140 and connects with the camera 120. In the illustrated embodiment, the bracket 140 includes a channel-shaped recess 148 formed in the rear leg 144, front leg 142, and body portion 146 of the bracket 140. The recess 148 may be sized and shaped to accommodate the electrical wire 150, whether the electrical wire 150 is surrounded by a wire guide that protects the electrical wire 150 or not. Without wishing to be limited by theory, the recess 148 of the bracket 140 ensures that the electrical wire 150 is securely arranged and retained within the bracket 140, minimizing the risk of damage or disconnection.

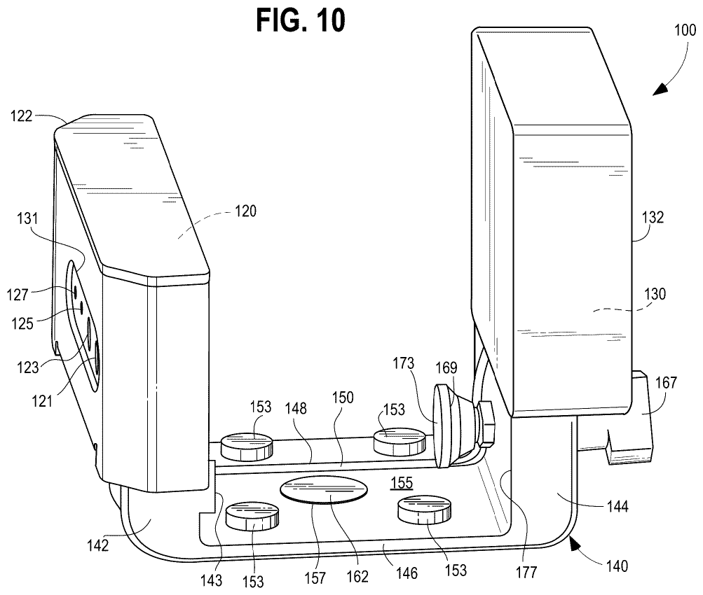

In certain implementations, the body portion 146 of the bracket 140 may include supporting pads 153 extending from the upwardly-facing surface 155 of the body portion 146 of the bracket 140, as shown, for example, in FIG. 10. When the body portion 146 of the bracket 140 does not include the supporting pads 153 as in the embodiments of FIGS. 7-8, when the bracket 140 is secured to the support member 118 of the item storage structure 112, the upwardly-facing surface 155 of the body portion 146 of the bracket 140 directly contacts and abuts the (downwardly-facing) bottom side 119d of the support member 118. On the other hand, in embodiments as shown in FIG. 10, where the body portion 146 of the bracket 140 includes supporting pads 153, if such a bracket 140 were secured to the support member 118 of the item storage structure 112, the upwardly-facing surface 155 of the body portion 146 of the bracket 140 would be spaced away from the bottom (downwardly-facing) side 119d of the support member 118, and would be separated by the supporting pads 153 from the bottom side 119d of the support member 118. The bottom side 119d of the support member 118 would rest on and be supported by the supporting pads 153, which may provide a more stable and secure connection between the bracket 140 and the support member 118 during and/or after installation.

With reference to FIG. 10, in some embodiments, the body portion 146 of the bracket 140 includes a magnet 162 that temporarily secures the bracket 140 to a support member 118 of the item storage structure 112 prior to the bracket 140 being permanently fixed with a fastener 164 (which will be discussed in more detail below). For example, during installation of the bracket 140 onto a metallic support member 118 of an item storage structure 112, the bracket 140 may be brought into proximity with the bottom side 119d of the support member 118, enabling the magnet 162 to attach to the bottom side 119d of the support member 118 via magnetic force alone, thereby bringing, and to bring the upwardly-facing surface 155 of the body portion 146 into direct contact/abutment with the bottom side 119d of the support member 118. Without wishing to be limited by theory, the magnetic feature of the bracket 140 according to the embodiment of FIG. 10 may advantageously allow for easy and precise alignment of the bracket 140 against the support member 118 during installation, ensuring that the bracket 140 is correctly positioned relative to the support member 118 before being fixedly attached by a fastener 164.

In certain aspects, the body portion 146 may include a single, centrally placed, circular magnet 162 that is disposed in a recess 157 in the upwardly-facing surface 155 of the body portion 146 such that no portion of the magnet 162 protrudes above the upwardly-facing surface 155 of the body portion 146, as shown, for example, in FIG. 10. It will be appreciated that the body portion 146 may include more than one magnet 162, that the magnet(s) 162 do not have to be centrally placed and may be located in different locations (e.g., proximate the corners of the body portion 146), and do not have to be disposed in the recess 157, and may slightly protrude from the upwardly-facing surface 155 of the body portion 146 of the bracket 140.

In certain aspects, the bracket 140 is rigidly attached to the support member 118 of an item storage structure 112 via a fastener 164, an example embodiment of which is shown in FIGS. 7-10. In the illustrated embodiment, the fastener 164 includes a head portion 166, a tail portion 168 opposite of the head portion 166, and a threaded portion 170 connecting the head portion 166 and the tail portion 168. In some aspects, the head portion 166 of the fastener 164 is configured to be grasped by a hand of a user to permit the user to rotate the fastener 164 via the hand. In other aspects, the head portion of the fastener 164 may be configured such that a tool may be coupled to the head portion 166 and the fastener 164 may be rotated via the tool. In some embodiments, the bracket 140 is configured such that the fastener 164 and the rear leg 144 of the bracket 140 are separate and distinct pieces that are not fixedly attached to each other such that the threaded portion 170 of the fastener 164 simply passes through an opening 165 in the rear wall 144, but the fastener 164 may be removed from and out of contact with the rear leg 144 of the bracket 140. In some aspects, the bracket 140 may be configured such that the fastener 164 and the rear leg 144 of the bracket 140 are formed as a unitary structure such that the threaded portion 170 of the fastener 164 may be rotated relative to the rear leg 144, but the fastener 164 may not be completely removed from or detached from the rear leg 144.

In the example shown in FIGS. 7 and 10, the tail portion 168 of the fastener 164 includes a mount 169 (but may include a suitable alternative feature) that may be securely tightened to a rear side 119b of the support member 118 to rigidly attach the bracket 140 to the support member 118. Also, in the example shown in FIGS. 7 and 10, the head portion 166 of the fastener 164 includes a knob 167 (but may include a suitable alternative feature) that permits a user to grasp the knob 167 and rotate the knob 167, together with the threaded portion 170 and the tail portion 168, to tighten the mount 169 against the rear side 119b of the support member 118, thereby rigidly attaching the bracket 140 to the support member 118.

Notably, the rigid attachment of the bracket 140 to the support member is provided by virtue of a portion of the rearwardly-facing surface 143 of the front leg 142 of the bracket 140 being in tight contact with the front side 119a of the support member 118, and the forwardly-facing surface 173 of the mount 169 being in direct contact and tight engagement with the rear side 119b of the support member 118, as shown in FIG. 7. On the other hand, if the fastener 164 were rotated in a loosening direction such that the forwardly-facing surface 173 of the mount 169 would move away from and out of contact with the rear side 119b of the support member 118, the bracket 140 would only be attached to the support member 118 by the magnet 162 (if present), enabling a user to easily remove the bracket 140 from the support member 118.

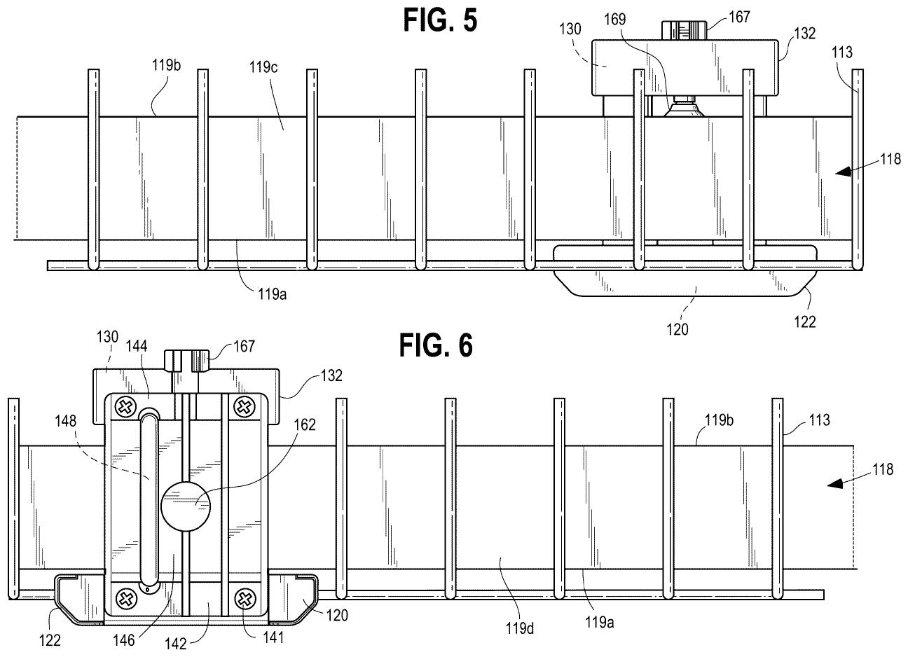

In the embodiment shown in FIGS. 7 and 10, the threaded portion 170 of the fastener 164 passes through an opening 165 the rear leg 144 of the bracket 140, such that the mount 169 of the fastener 164 is located on one side of the rear leg 144 and is located between the front leg 142 and the rear leg 144, while the head portion 166 of the fastener 164 is located on an opposite side of the rear leg 144 and outside of the space between the front leg 142 and the rear leg 144. As shown, for example, in FIGS. 5 and 7, the top side 119c of the support member 118 may support a portion of the product storage/display shelf 113 of the item storage structure 112. In the embodiment shown in FIG. 7, the bracket 140 is mounted to the support member 118 such that no portion of the bracket 140 extends above the top side 119c of the support member 118.

On the other hand, the bracket 140 is securely mounted onto the support member 118 from the bottom, such that the body portion 146 extends across the thickness of the support member 118 underneath the bottom side 119d of the support member 118, while the front leg 142 and rear leg 144 extend along portions of the front side 119a and rear side 119b of the support member 118, respectively. As such, the bracket 140 is oriented to wrap around the support member 118 from the bottom and around portions of two sides (i.e., 119a and 119b) of the support member 118, as shown, for example, in FIGS. 6 and 7. In the example shown in FIG. 7, a length of the body portion 146, which may be defined as the distance from the front leg 142 to the rear leg 144, is greater than the maximum thickness of the support member 118, which may be defined as the maximum distance between the front side 119a to the rear side 119b of the support member 118. As a result, one or more portions of the rearwardly-facing surface 143 of the front leg 142 may be spaced apart from and not in contact with the front side 119a of the support member 118. Similarly, a portion of the forwardly-facing surface 177 of the rear leg 144 may be spaced apart from the rear side 119b of the support member 118, as shown in FIG. 7.

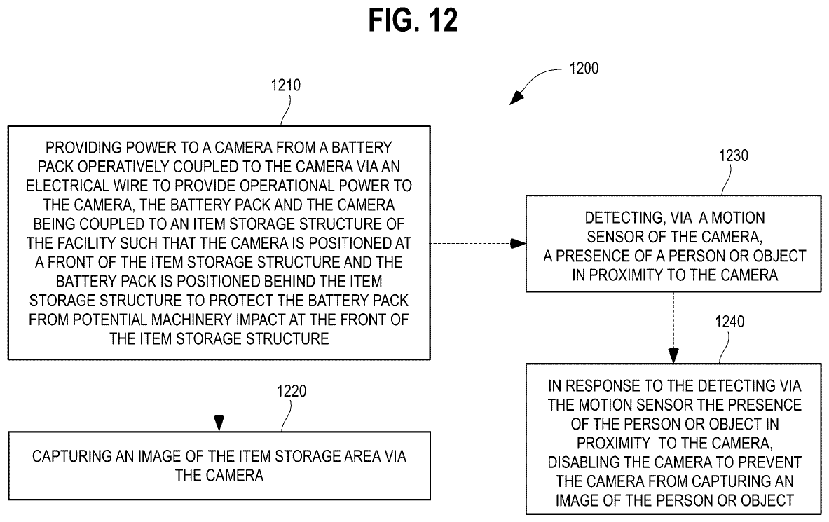

FIG. 12 shows an embodiment of a method 1200 of monitoring an item storage area of a facility. At block 1210, the method 1200 includes providing power to a camera, the camera having a field of view that includes the item storage area of the facility, from a battery pack operatively coupled to the camera via an electrical wire to provide operational power to the camera, the battery pack and the camera being coupled to an item storage structure of the facility such that the camera is positioned at a front of the item storage structure and the battery pack is positioned behind the item storage structure to protect the battery pack from potential machinery impact at the front of the item storage structure. At block 1220, the method 1200 includes capturing an image of the item storage area via the camera.

As shown in FIG. 12, in certain aspects, the method 1200 may optionally include detecting, via a motion sensor of the camera, a presence of a person or object in proximity to the camera (step 1230). In addition, in as shown in FIG. 12, in certain aspects, in response to step 1230, the method 1200 may further optionally include disabling the camera to prevent the camera from capturing an image of the person or object detected by the motion sensor (step 1240).

The systems, devices, and methods relating to mounting a camera in a facility to monitor a product storage area as described herein offer significant advantages in terms of both functionality and protection. For example, the position of the mounting system ensures that the camera's field of view effectively covers the product storage area of interest, while the battery pack is securely housed at the back of a portion of a storage structure, protecting the battery pack from potential damage by machinery at the front of the storage structure. As such, the mounting system advantageously minimizes the exposure of the battery pack to external impacts.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. A system for monitoring an item storage area of a facility, the system comprising:
a first housing containing a camera having a field of view that includes the item storage area of the facility;
a second housing containing a battery pack operatively coupled to the camera to provide operational power to the camera;
an electrical wire coupled to the battery pack and the camera; and
a bracket mounted to an item storage structure in the item storage area, the bracket including:
a front leg having a surface that rigidly contacts a front of the item storage structure facing an aisle and supports the first housing at the front of the item storage structure facing the aisle;
a rear leg having a fastener that rigidly contacts a back of the item storage structure facing away from the aisle and supports the second housing at the back of the item storage structure facing away from the aisle; and
a body portion that connects the front leg and the rear leg, wherein the electrical wire travels along the body portion between the front leg and the rear leg;
wherein the bracket situates the battery pack proximate the rear leg behind the item storage structure to protect the battery pack from potential machinery impact at the front of the item storage structure.

2. The system of claim 1, wherein:
the camera includes a motion sensor that detects a motion indicative of the presence of a person in proximity to the camera; and
in response to a detection by the sensor of the motion, the camera is disabled to prevent the camera from capturing an image of the person.

3. The system of claim 2, wherein the motion sensor is one or more of a passive infrared (PIR) sensor, microwave field disturbance sensor, a light detection and ranging (LIDAR) sensor, an ultrasonic sensor, and a thermal sensor.

4. The system of claim 1, wherein:
the first housing is coupled to the front leg of the bracket by at least one fastener; and
the second housing is coupled to the rear leg of the bracket by at least one fastener.

5. The system of claim 1, wherein the body portion of the bracket includes a recess that retains at least a portion of a wire guide containing the electrical wire therein.

6. The system of claim 1, wherein:
the front leg of the bracket includes at least one opening that permits at least one fastener to pass therethrough to fixedly attach the first housing to the front leg of the bracket; and
the rear leg of the bracket includes at least one opening that permits at least one fastener to pass therethrough to fixedly attach the second housing to the rear leg of the bracket.

7. The system of claim 1, wherein the body portion of the bracket includes a magnet to secure the bracket to the item storage structure prior to the bracket being secured to the item storage structure by the fastener.

8. The system of claim 7, wherein:
the item storage structure to which the bracket is mounted includes a bar or beam, the bar or beam including a front side, a rear side, a top side, and a bottom side; and
the body portion of the bracket extends across a thickness of the bar or beam below the bar or beam, such that the front leg of the bracket, the rear leg of the bracket, and the body portion of the bracket are oriented to wrap around at least a portion of the front side of the bar or beam, the rear side of the bar or beam, and the bottom side of the bar or beam.

9. The system of claim 8, wherein the body portion of the bracket includes a plurality of upwardly-facing supporting pads configured to contact a downwardly-facing surface of the bar or beam and support the bar or beam thereon.

10. The system of claim 9, wherein the fastener includes:
a threaded portion passing through the rear leg of the bracket;
a tail portion located on one side of the rear leg of the bracket and including a mount for engaging the rear side of the bar or beam; and
a head portion located on an opposite side of the rear leg of the bracket relative to the tail portion and including a knob for rotating the threaded portion and tightening the mount to the rear side of the bar or beam.

11. A bracket to mount a camera and a battery pack, the camera and the battery pack being interconnected by an electrical wire, to an item storage structure of a facility, the bracket comprising:
a front leg having a surface that rigidly contacts a front of the item storage structure facing an aisle and supports a first housing containing the camera at the front of the item storage structure facing the aisle;
a rear leg having a fastener that rigidly contacts a back of the item storage structure facing away from the aisle and supports a second housing containing the battery pack at the back of the item storage structure facing away from the aisle; and
a body portion that connects the front leg and the rear leg, wherein the electrical wire travels along the body portion between the front leg and the rear leg;
wherein the bracket situates the battery pack proximate the rear leg behind the item storage structure to protect the battery pack from potential machinery impact at the front of the item storage structure.

12. The bracket of claim 11, wherein the body portion of the bracket includes a recess that retains at least a portion of a wire guide containing the electrical wire therein.

13. The bracket of claim 11, wherein the body portion of the bracket includes a magnet to secure the bracket to the item storage structure prior to the bracket being secured to the item storage structure by the fastener.

14. The bracket of claim 11, wherein the body portion of the bracket includes a plurality of upwardly-facing supporting pads configured to contact a downwardly-facing surface of the item storage structure.

15. The bracket of claim 11, wherein:
the item storage structure to which the bracket is mounted includes a bar or beam, the bar or beam including a front side, a rear side, a top side, and a bottom side; and
the body portion of the bracket extends across a thickness of the bar or beam below the bar or beam, such that the front leg of the bracket, the rear leg of the bracket, and the body portion of the bracket are oriented to wrap around at least a portion of the front side of the bar or beam, the rear side of the bar or beam, and the bottom side of the bar or beam.

16. The bracket of claim 15, wherein the fastener includes:
a threaded portion passing through the rear leg of the bracket;
a tail portion located on one side of the rear leg of the bracket and including a mount for engaging the rear side of the bar or beam; and
a head portion located on an opposite side of the rear leg of the bracket relative to the tail portion and including a knob for rotating the threaded portion and tightening the mount to the rear side of the bar or beam.

17. The bracket of claim 11, wherein the front leg is securely attached to the first housing via at least one fastener, and wherein the rear leg is securely attached to the second housing via at least one fastener.

18. A method of monitoring an item storage area of a facility, the method comprising:
providing power to a camera, the camera having a field of view that includes the item storage area of the facility, from a battery pack operatively coupled to the camera via an electrical wire to provide operational power to the camera, the battery pack and the camera being coupled to an item storage structure of the facility such that the camera is positioned at a front of the item storage structure and the battery pack is positioned behind the item storage structure to protect the battery pack from potential machinery impact at the front of the item storage structure; and
capturing an image of the item storage area via the camera.

19. The method of claim 18, further comprising:
detecting, via a motion sensor of the camera, a presence of a person or object in proximity to the camera; and
in response to the detecting via the motion sensor the presence of the person or object in proximity to the camera, disabling the camera to prevent the camera from capturing an image of the person or object.

20. The method of claim 19, wherein the camera and the battery pack are coupled to the item storage structure via a bracket mounted to the item storage structure, the bracket including: a front leg having a surface that rigidly contacts a front of the item storage structure facing an aisle and supports a first housing containing the camera at the front of the item storage structure facing the aisle, a rear leg having a fastener that rigidly contacts a back of the item storage structure facing away from the aisle and supports a second housing containing the battery pack at the back of the item storage structure facing away from the aisle, and a body portion that connects the front leg and the rear leg, wherein the electrical wire travels along the body portion between the front leg and the rear leg.
